(19) United States
(12) Patent Application Publication
(10) Pub. No.: US 2021/0008482 A1
(43) Pub. Date: Jan. 14, 2021

(54) SYSTEM AND METHOD TO VERIFY REPLACEMENT OF A HEATING-VENTING AND AIR-CONDITIONING SYSTEM AIR FILTER

(71) Applicant: Violeta Staykova, Jacksonville, FL (US)

(72) Inventor: Violeta Staykova, Jacksonville, FL (US)

(21) Appl. No.: 16/507,582

(22) Filed: Jul. 10, 2019

(51) Int. Cl. B01D 46/00; H04W 4/029; H04N 5/232; G08C 23/04

(52) U.S. Cl. CPC B01D 46/0086; B01D 46/008; B01D 46/009; B01D 2279/35; H04N 5/23222; G08C 23/04; B01D 2273/18; H04W 4/029

(57) ABSTRACT

A system and method are provided for verifying replacement of an air filter in a heating ventilation and air conditioning (HVAC) system in a building includes: accessing an HVAC system air filter replacement verification software application (HVAC Filter App) on a mobile device (MD); using a camera on the mobile device as prompted by the HVAC Filter App to take one or more photos of an old air filter as installed in the HVAC system (first set of photos); saving the first set of photos on the MD; using a camera on the mobile device as prompted by the HVAC Filter App to take one or more photos of a new air filter prior to being installed in the HVAC system (second set of photos); saving the second set of photos on the MD; using a camera on the mobile device as prompted by the HVAC Filter App to take one or more photos of the new air filter as installed in the HVAC system (third set of photos); saving the third set of photos on the MD; forwarding the first, second, and third set of photos using the HVAC Filter App; and performing a comparison of the first, second, and third set of photos to verify the new air filter has been installed in the HVAC system.

### TECHNICAL FIELD

The embodiments described herein relate generally to property maintenance, and more specifically to systems, methods, and modes for protecting expensive heating, ventilation, and air conditioning (HVAC) systems through the use of an application that can be installed on a personal electronic device (PED) to verify the replacement of the air filter device.

### BACKGROUND

Americans spend significant amounts of money to purchase homes and/or investment properties. In many, if not most, locations within the U.S., there is a need for heating and/or air-conditioning (commonly referred to as “heating ventilation and air-conditioning (HVAC) systems). Heating systems can take many different forms, such as air driven systems in which a carbon-based fuel is burned to create heat that is passed to intake air and distributed at a raised temperature to heat a home. Such air driven systems can also use electricity, or geothermal sources for heat. Many homes use a closed system water baseboard oil burner system, in which fuel oil is burned to generate heat that is transferred to water which is then piped around a house, and radiators, generally in the form of baseboard heaters or stand-alone radiators, transfer the heat to the surrounding air. As those of skill in the art can appreciate, air driven systems typically include air filters to prevent dust, pet hair, and other air-borne debris from being distributed around the home, and/or damaging the air driven system.

Air conditioner (AC) systems almost always require cooled air to be distributed around the home. Typically, such AC systems can include ductwork that transports the cooled air to rooms in the house, and ductwork to return warmer air to the AC system. Two other AC systems are fairly prevalent in the U.S.: ductless AC systems, and wall/window mounted units. In the former, the components of the larger duct-based systems are replicated in smaller units that can be mounted on walls and be used to cool a single room without all of the expense of ductwork being installed in a house. In wall/window mounted units, heat is expelled directly outside, and cool air discharged directly from the unit into the room in which the unit is located; there is no ductwork.

Heating and air conditioning systems, especially air driven systems, can be combined, and referred to as “heating ventilation and air-conditioning systems” or “HVAC” systems.

Many experts in the HVAC industry suggest replaced the least expensive component of the HVAC system at least once a month, as such replacement substantially reduces the likelihood of damage occurring to the components of such systems, as well as reducing the likelihood of spreading contaminants such as dander and other airborne particles throughout the household or building.

Furthermore, these systems can be very expensive, depending on the size of the building or house to be cooled/heated. Costs for single family homes can range from $4000 to over $12000, by way of example. Filters generally cost between $2-$5 a piece depending on the technology. Assuming an average cost of $3.50, replaced monthly, over a 20 year life span, the cost of the filters is less than $850, which is only 21% of the cost of the least expensive HVAC system, and spread out over 20 years. For the more expensive systems, replacement of a filter once a month is about 7% of the price, again, spread out over 20 years.

While homeowners might have an interest in protecting their investment, it can be difficult to make tenants appreciate such concerns, especially when a good portion of them have never owned their own home or building. Even when leases contain clauses that include such provision as “must replace the HVAC filter on a monthly basis,” it can be the case that the tenant forgets. Landlords can find it difficult to justify the expense to verify replacement on a monthly basis; however, it is typically the case that security deposits will not even come close to replacement costs of the HVAC system in the event it fails due to lack of such maintenance, if it can even be proved that “but for” the failure to replace the filters caused the HVAC system 100 to fail.

Thus, there is a need for systems, methods, and modes to protect expensive heating, ventilation, and air conditioning (HVAC) systems through the use of an application that can be installed on a personal electronic device (PED) to verify the replacement of the air filter device.

### SUMMARY

An object of the embodiments is to substantially solve at least the problems and/or disadvantages discussed above, and to provide at least one or more of the advantages described below.

It is therefore a general aspect of the embodiments to provide systems, methods, and modes for protecting expensive heating, ventilation, and air conditioning (HVAC) systems through the use of an application that can be installed on a personal electronic device (PED) to verify the replacement of the air filter device that will obviate or minimize problems of the type previously described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

In an exemplary embodiment, a method is provided for verifying replacement of an air filter in a heating ventilation and air conditioning (HVAC) system in a building. The method may include: accessing an HVAC system air filter replacement verification software application (HVAC Filter App) on a mobile device (MD); using a camera on the mobile device as prompted by the HVAC Filter App to take one or more photos of an old air filter as installed in the HVAC system (first set of photos); saving the first set of photos on the MD; using a camera on the mobile device as prompted by the HVAC Filter App to take one or more photos of a new air filter prior to being installed in the HVAC system (second set of photos); saving the second set of photos on the MD; using a camera on the mobile device as prompted by the HVAC Filter App to take one or more photos of the new air filter as installed in the HVAC system (third set of photos); saving the third set of photos on the MD; forwarding the first, second, and third set of photos using the HVAC Filter App; and performing a comparison of the first, second, and third set of photos to verify the new air filter has been installed in the HVAC system.

In an exemplary embodiment, the method further includes verifying a location of the installation of the new air filter and the MD using a global positioning system (GPS) application accessible by the mobile device. The step of verifying a location can further include using a cellular telephone system location determining application (locating determining App) accessible by the MD to determine a location of the MD. Also, the step of performing a comparison can include: comparing the old air filter to the new air filter to verify they match; and verifying that the new air filter has been installed in the HVAC system, and that the address of both the HVAC system and MD match, and that the address of the MD match previously stored records of the HVAC system.

In an exemplary embodiment, the method further includes: verifying that the new air filter is a correct replacement air filter for the HVAC system by analyzing a universal product code (UPC) of the new air filter. Also, it may further include verifying that the new air filter is a correct replacement air filter for the HVAC system by determining a size of the new air filter and verifying it matches a size requirement of an air filter for the HVAC system at the address of the building. The method can also include verifying that the new air filter is a correct replacement air filter for the HVAC system by analyzing a universal product code (UPC) and verifying that the new air filter is correct for the HVAC based on records linking the location of the MD, the address of building, and the HVAC recorded as installed at the address of the building. It can also include verifying that the new air filter has been installed properly within the HVAC system by testing the new air filter using an optical transmission characteristic of the new air filter.

In an exemplary embodiment, the method includes verifying that the new air filter has been installed properly within the HVAC system by measuring airflow through the new filter using an air pump adapted to pump a flow of air through the new air filter, and a pressure measurement transducer adapted to measure the pumped air flow through the new air filter. Here, the correct air flow orientation of the new air filter can be determined by measuring an air flow through the new filter using an air pump adapted to pump a flow of air through the new air filter, and a pressure measurement transducer adapted to measure the pumped air flow through the new air filter.

In an exemplary embodiment, the steps of taking the first, second, and third set of photos, and forwarding the same can be prompted by the HVAC Filter App stored on the MD. Also, the method may include: receiving the first, second, and third sets of photos at a server, wherein the server is adapted to store an HVAC Filter Main App that is adapted to receive the three sets of photos, and perform the steps of: matching a location of the MD forwarding the photos to an address stored in memory for the building; verifying that the new air filter is a correct replacement for the HVAC system associated with the building; verifying that the new air filter has been correctly installed into the HVAC system; and forwarding a first electronic correspondence to a resident of the building confirming the installation of the new air filter, and forwarding a second electronic correspondence to one or more of a landlord, property manager, and owner of the building confirming installation of the new air filter.

In certain exemplary embodiments, a system is provided. The system may be for verifying replacement of a new air filter for an old air filter in a heating venting and air conditioning (HVAC) system in a building, comprising: a mobile device (MD) belonging to and operated by a resident of the building and adapted to communicate electronically through an electronic communications network (network) and further adapted to take photos with a camera, and which is further adapted to store and execute a set of programming instructions entitled HVAC Filter App, wherein the HVAC App is adapted to periodically prompt the resident to use the camera to take three sets of photos, wherein the first set of photos comprise one or more photos of an old air filter as installed in the HVAC system (first set of photos), the second set of photos comprise one or more photos of a new air filter prior to being installed in the HVAC system (second set of photos), the third set of photos comprise one or more photos of the new air filter installed into the HVAC system (third set of photos), and wherein the HVAC App is further adapted to store the three sets of photos, forward the three sets of photos through the network in a first HVAC installation report, and receive electronic correspondence verifying installation of the new air filter into the HVAC system.

In an exemplary embodiment of the system, the MD is adapted to use one or more of a global positioning system (GPS) application (App) accessible by the MD and cellular telephone network location determining application (location determining App) accessible by the MD to determine a present location of the MD, and the HVAC Filter App is adapted to retrieve the present location of the MD, and include the present location of the MD in the first HVAC installation report.

The system may also include: a first computing device (first computer) belonging to and operated by an administrator, the first computer adapted to communicate electronically through the network and is further adapted to store and execute a set of programming instructions entitled HVAC Filter Main App; and wherein the HVAC Filter Main App is adapted to receive the three sets of photos in the first HVAC installation report, compare the old air filter to the new air filter to verify they match, verify that the new air filter has been installed in the HVAC system, verify that the address of both the HVAC system and MD match, verify that the address of the MD match previously stored records of the HVAC system, and send the electronic correspondence verifying installation of the new air filter into the HVAC system. In an embodiment, the second set of photos includes an image of a universal product code (UPC) of the new air filter, and the HVAC Filter Main App is further adapted to verify that the new air filter is a correct replacement air filter for the HVAC system installed at the building by analyzing the UPC of the new air filter, and by reviewing records linking the location of the MD, the address of building, and the HVAC recorded as installed at the address of the building.

In the system, the second set of photos can further include at least one image of the new air filter from which a size of the new air filter can be determined, and wherein the HVAC Filter Main App can be further adapted to verify the new air filter is a correct replacement air filter for the HVAC installed at the building by checking that the size of the new air filter matches a specified size for the replacement air filter for the HVAC system installed at the building.

In an exemplary embodiment, a sensor system is adapted to verify that the new air filter has been installed, the sensor system comprising an optical transmitter adapted to transmit a first optical signal through the new air filter, an optical detector being adapted to receive the transmitted optical signal and output a detection signal, the detection signal including optical characteristics of the receiving optical signal including at least a magnitude of the detected signal, and a processor adapted being provided to receive the detection signal and evaluate the magnitude of the received optical signal to determine whether a new air filter has been installed in the HVAC system.

The system may further include: a sensor system adapted to verify that the new air filter has been properly installed, the sensor system including: an air pump adapted to pump a first flow of air through the new air filter, a pressure transducer adapted to receive the pumped first flow of air and output a detection signal, the detection signal including pumped air characteristics of the received pumped flow of air including at least a magnitude of the detected signal, and a processor adapted to receive the detection signal and evaluate the magnitude of the received pumped flow of air to determine whether a new air filter has been installed in the HVAC system.

In a particular further embodiment, the system may further include: a second computing device (second computer) belonging to and operated by one or more of an owner, property manager, and landlord of the building (owner), the second computer adapted to communicate electronically through the network and is further adapted to store and execute a set of programming instructions entitled HVAC Filter Report App, and wherein the HVAC Filter Report App is adapted to accept information pertaining to a new user of the system input by the owner, and add the new use to the system by preparing and transmitting first new user correspondence to the user, and by preparing and transmitting second new user correspondence to the first computer and the HVAC Filter Main App, and further wherein the HVAC Filter Main App is further adapted to prepare periodic reports on one or more users of the system and send the same to the owner periodically.

### BRIEF DESCRIPTION OF THE DRAWINGS

The above and other objects and features of the embodiments will become apparent and more readily appreciated from the following description of the embodiments with reference to the following figures, wherein like reference numerals refer to like parts throughout the various figures unless otherwise specified, and wherein:

FIG. 1 is a block diagram depicting basic components of a heating ventilation and air conditioning system.

FIG. 2 illustrates several locations in which different aspects of a system and method for verifying replacement of an HVAC air filter can be implemented and used according to aspects of the embodiments.

FIG. 3 illustrates a flow diagram of a method of using an HVAC Air Filter Replacement Reminder software application (AC-Filter App) according to aspects of the embodiments.

FIGS. 4A, 4B, 4C, 4D, 4E, 4F and 4G illustrate a plurality of graphical user interface (GUI) diagrams/screenshots displayed on a personal electronic device (PED) or mobile device (MD) of a tenant—user upon which the AC-Filter App has been installed according to aspects of the embodiments.

FIGS. 5A and 5B illustrate a first and second graphical user interface diagram/screenshot displayed on a personal electronic device, personal computer, and/or mobile device of a property owner/property manager—user upon which the AC-Filter Report App has been installed according to aspects of the embodiments.

FIG. 6 illustrates a block diagram of an air handler and a filter installation sensor System for use with the network described in regard to FIG. 2, a method of verifying installation of a new HVAC air filter as described in regard to FIG. 3, and the graphical user interfaces of FIGS. 4A, 4B, 4C, 4D, 4E, 4F and 4G, and 5A and 5B, as described therein, according to aspects of the embodiments.

FIG. 7 illustrates a functional block diagram of the personal electronic device that can be used with the AC-Filter App according to aspects of the embodiments.

FIG. 8 illustrates a block diagram of a network system within which the system and method for verifying installation of a new HVAC air filter can be implemented according to aspects of the embodiments.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the concept to those skilled in the art. The scope of the embodiments is therefore defined by the appended claims. The following embodiments are discussed, for simplicity, with regard to the terminology and structure of a 4G/LTE so-called “smart phone” and home heating ventilation and air conditioning (HVAC) system. However, the embodiments to be discussed next are not limited to these systems but may be applied to other types of property, such as commercial rental property, in which expensive HVAC systems can be damaged due to lack of property maintenance.

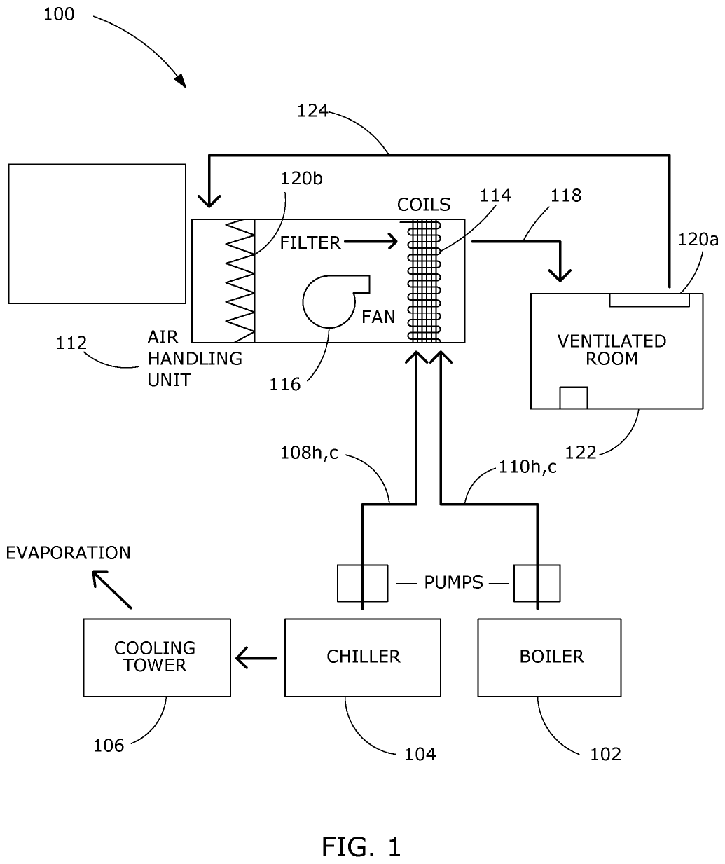

As those of skill in the art can appreciate, heating and air conditioning systems, especially air driven systems, can be combined, and referred to as “heating ventilation and air-conditioning systems” or “HVAC” systems. FIG. 1 illustrates such a system.

In FIG. 1, HVAC system (system) 100 comprises air handling unit 112, supply ductwork 118, room 122, second filter 120b, return ductwork 124, second filter 120b, fan 116, coils 114, chiller 104, boiler/furnace 102, and evaporative cooler 106. Running to and from coils 114 from chiller 104 are hot and cold lines 108h,c, respectively, and running to and from coils 114 from boiler/furnace 102 are hot and cold lines 110h,c, respectively. As those of skill in the art can appreciate, the diagram in FIG. 1 is greatly simplified, but provides an adequate overview of such systems in view of the aspects of the embodiments, described below.

In system 100, cooled liquid is pumped from chiller 104 via cold line 108c to coils 114. Fan 116 pulls hot air from room 122 through second filter 120b, and forces it over coils 114. As such, the air is cooled prior to be sent, via supply ductwork 118 to room 122. Room 122 will cool down with the introduction of the cooled air, and then system 100 typically is turned off (usually automatically via a thermostat, not shown). After a while, the air in room 122 heats up and the thermostat turns the air conditioning system back on again. Hot air is pulled out of room 120 through first filter 120a, through return ductwork 124 and through second filter 120b, and the process repeats. Hot air heats up the liquid in the coils, turning it into a gas, which is returned to chiller 104, which sends it to evaporative cooler 106 (typically located outside the house or building), and the heat in the gas is expelled into the environment. The now cooled liquid is returned to chiller 104 and then pumped to coils 114 via cold line 108c, wherein the warmed return air is pulled by fan 116 through coils 114 and the air is cooled.

A substantially similar process occurs when heating room 122, but since this portion of the system seeks to heat the returned air, there is nothing to expel as on the air conditioning side. Nonetheless, as those of skill in the art can appreciate, in both the heating and cooling portions of system 100, air must pass through a filter 120 at least once. Most systems 100 only have one filter, located at either end as shown in FIG. 1.

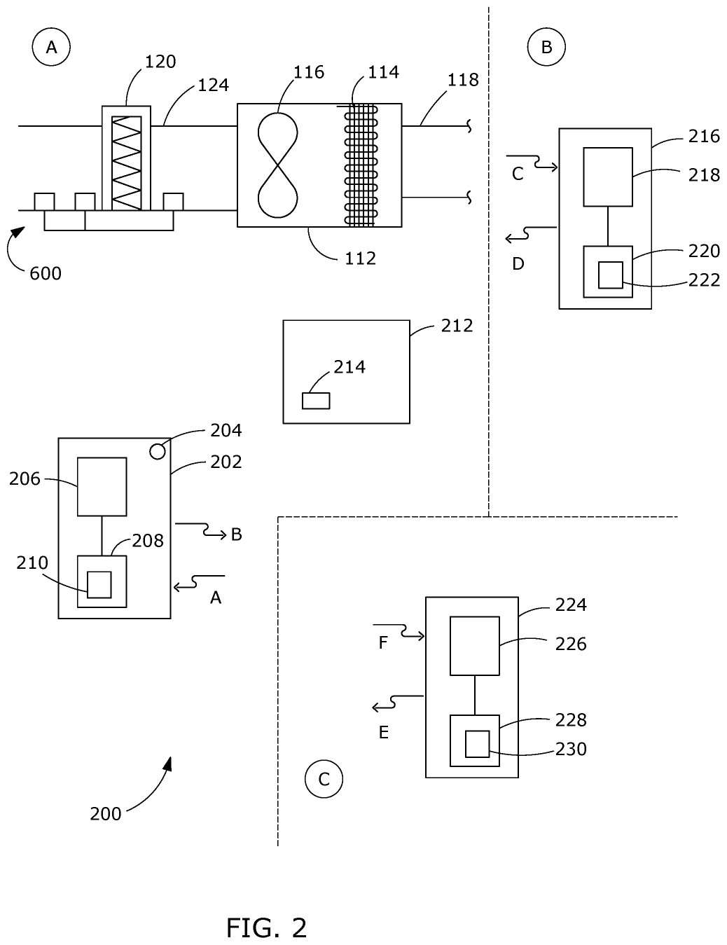

FIG. 2 illustrates several locations of HVAC filter replacement network (network) in which different aspects of a system and method for verifying replacement of an HVAC air filter can be implemented and used according to aspects of the embodiments.

According to aspects of the embodiment, the systems, methods, and modes described herein that protect costly HVAC systems is embodied as several components, which are located in several locations. These components include a software application (App) that can be down loaded on a user's personal electronic device (PED) or, more commonly, mobile device (MD) 202, such as a cellular phone. In fulfillment of the dual purposes of clarity and brevity, and not to be taken in a limiting manner, this discussion will only refer to use of MD 202 as a means for storing and using the App, described below. Such MDs 202 will include a camera and lens (camera) 204, the use of which is discussed in greater detail below. The App can be referred to as HVAC Air Filter Replacement App (AC Filter App) 210, and is stored on MD 202. Typically, AC Filter App 210 is used by a tenant in response to a clause in a lease inserted therein by the landlord, owner, or property manager who wants to protect their valuable HVAC system 100 asset.

The landlord/property manager/owner (collectively referred to as “owner”) has a different but related version of AC Filter App 210 that receives reports from the one or more tenants that use AC Filter App 210 in compliance with their leases. The software that the owner uses can be referred to as AC Filter Report App 230, and can be installed on a MD 202, or more likely on personal computer (PC) 224. Such PCs 224 can be a laptop, tower-based system, or any other PED that has electronic communications, processing, and storage capabilities. In fulfillment of the dual purposes of clarity and brevity, and not to be taken in a limiting manner, reference will be made to use of PC 224 by the owner. AC Filter Report App 230 receives notifications from the one or more tenants when fulfilling their responsibilities in regard to filter 120 replacement, in a manner described in greater detail below. AC Filter Report App 230 also communicates with AC Filter Main App 22.

AC Filter Main App 222 is software that is maintained and run by an administrator of the systems, methods, and modes of the aspects of the embodiments. That is, the collection of AC filter applications is owned/operated by an entity, and the main software component, AC Filter Main App 222, resides typically on a server computer (server) 216, and run by an administrator. Those of skill in the art should appreciate that the use of server 216 is not to be taken in a limiting manner, as any computing device that includes a processor, memory, and electronic communication capabilities (among other necessary components) can be used. However, in fulfillment of the dual purposes of clarity and brevity, and not to be taken in a limiting manner, reference shall be made only to server 216 as a means for storing AC Filter Main App 222.

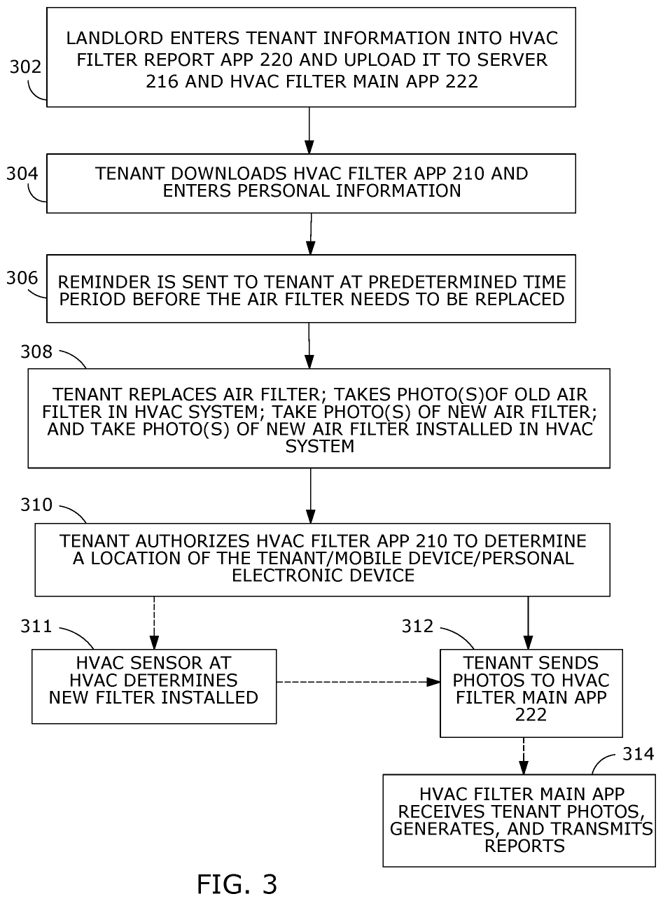

There are three locations shown in FIG. 3: Locations A, B, and C. Each of the Locations A, B, and C, pertains to an area in which a particular user of the aspects of the embodiments is located, and runs/uses their particular App or software components. Location A is the designated location for the tenant. In Location A, typically a single-family home, condo, or apartment, a tenant or homeowner is located with MD 202. MD 202 comprises, among other components, processor 206, memory 208, and stored in memory 208 is AC Filter App 210. MD 202 is discussed in greater detail below. According to aspects of the embodiments, AC Filter App 210 can be used by a tenant or a homeowner. Also shown in FIG. 2 as part of Location A is part of HVAC system 100 of FIG. 1: return ductwork 124, old filter 120, air handler 112, within which is fan 116, and coils 114, and supply ductwork 118.

Location B is the location designated for the administrator and server 216. Server 216 stores AC Filter Main App 222 in memory 220, and server 216 further includes, among other components, processor 218. AC Filter Main App 222 collects data sent by tenants and prepares reports for the owners, shown in Location C. The owner in Location C typically uses PC 224 to store and run AC Filter Report App 230. Use of each of AC Filter Main App 222 and AC Filter Report App 230 are discussed in greater detail below.

FIG. 3 illustrates a flow diagram of method 300 for use of AC Filter App 210, AC Filter Main App 222, AC Filter Report App 230 according to aspects of the embodiments.

For the purposes of discussion of the flow diagram of method 300, and not to be taken in a limiting manner, according to aspects of the embodiments, reference will be made to a tenant, and not a homeowner as using AC Filter App 210, and an owner, and not property manager as using AC Filter Report App 230, and an administrator using/operating network 200 and AC Filter Main App 222.

An encoding process is discussed with reference to FIG. 3. This encoding process is not meant to limit the embodiments, nor to suggest that any particular embodiment should be implemented following this encoding process. The purpose of the following encoding process is to facilitate the understanding of an embodiment and to provide the reader with one of many possible implementations of the processes discussed above. FIG. 3 shows a flow chart illustrating various steps performed during the encoding process. The steps shown in FIG. 3 are not intended to completely describe the encoding process but only to illustrate some of the aspects discussed above, nor should they be construed to indicate that any particular order of steps needs to occur, unless otherwise so indicated.

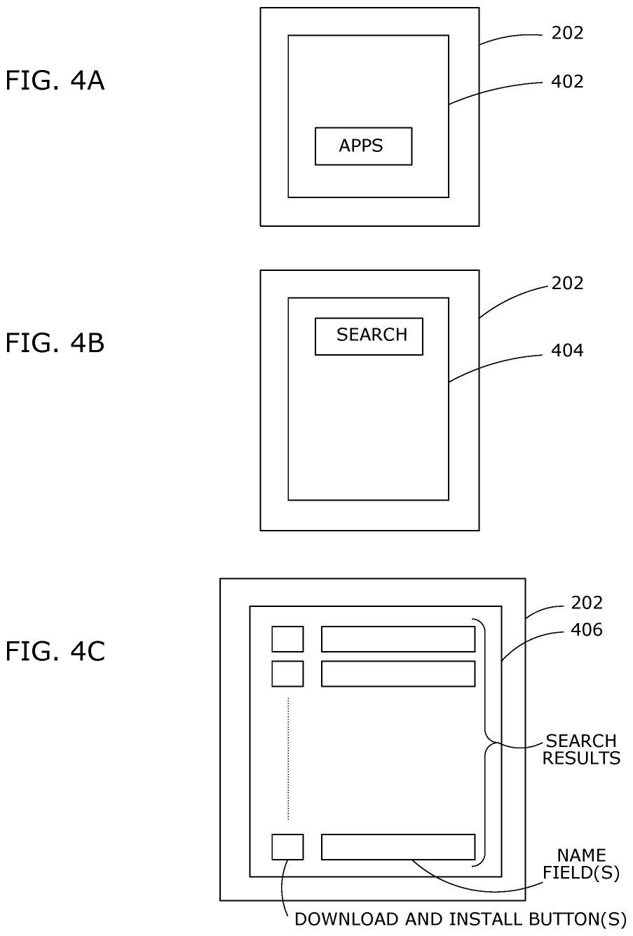

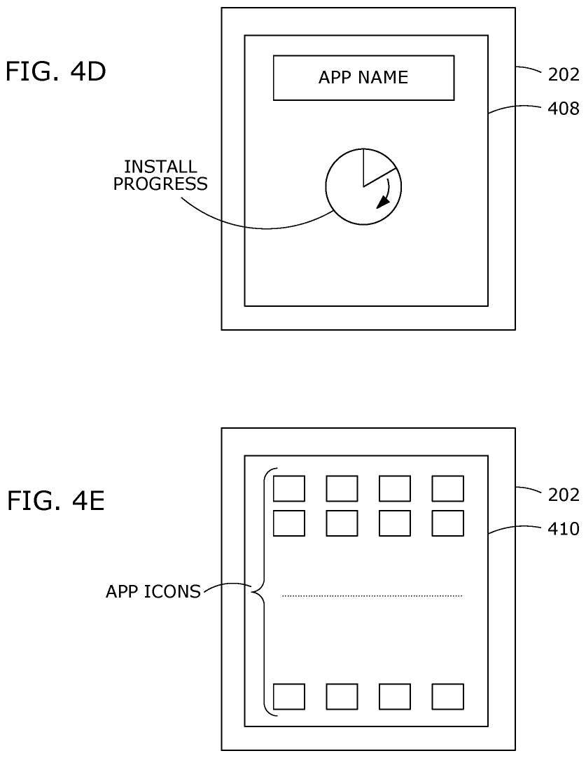

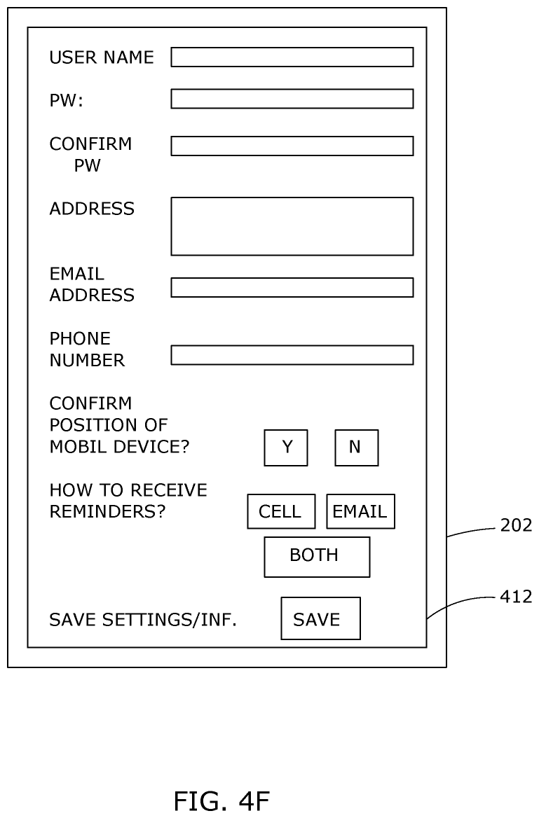

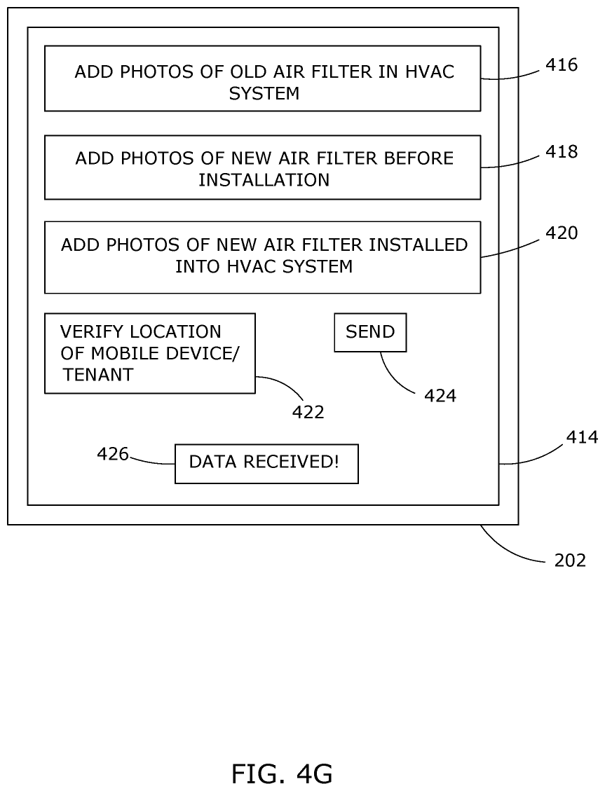

Method 300 begins with method step 302 in which the landlord enters the tenant data in AC Filter Report App 230. Such data will include the tenant's name, address of the property, telephone number(s), email address(es) (tenant information). The tenant information is uploaded to server 216, in conjunction with AC Filter Main App 222, and stored in memory 220. The tenant can then download AC Filter App 210; these actions are also shown and discussed in regard to FIGS. 4A-4H, which are screenshots or graphical user interfaces (GUIs) seen on MD 202 when using method 300 according to aspects of the embodiments.

Method 300 then proceeds to method step 304, in which the tenant downloads AC Filter App 210. Upon downloading and then opening AC Filter App 210, the tenant is requested to enter some information such as name, address, telephone number and email address. The tenant is further asked to give permission to allow location address when uploading photos, as discussed in greater detail below. Without such authorization, however, the tenant cannot use AC Filter App 210, as one fundamental component of verification of replacement of filter 120 in HVAC system 100 is to match the location of the replaced filter with the tenant address. Position information can be obtained by AC Filter App 210 through use of a global position system (GPS) application, cellular telephone system position determination application, or a combination thereof, or other means, according to aspects of the embodiments. Once all of the tenant data has been entered, the tenant sends the data to server 216, and a report is sent to the landlord, typically via email and/or text message, indicating that the tenant at such an address has successfully downloaded AC Filter App 210 and registered.

Following step 304, method 300 proceeds to method step 306 in which AC Filter Main App 222 sends a reminder to the tenant about a week before the scheduled date to replace the air filter in the HVAC system where the tenant resides. The reminder can be set up to be sent every day, every few days, or just this first time and then again on the actual date, typically the first of the month. Other reminder scenarios are possible according to aspects of the embodiments.

In method step 308, the tenant has decided to replace the old air filter 120a, with a new air filter 212. It can be the case that there are multiple air filters, but for purposes of this discussion, the replacement of one will be used to simplify the discussion; in addition, those of skill in the art can appreciate that other types of filter technologies are encompassed within the aspects of the embodiments, such as electronic ai filters, which periodically need to be washed and which use static electricity to clean the air; network 200 and method 300 according to aspects of the embodiments encompasses all different types of filter technologies that need to be periodically replaces and/or cleaned. According to still further aspects of the embodiments, network 200 and method 300, and the discussion of MD 202, and the GUIs that are displayed on MD 202 can be used with other periodic duties that tenants and others need to perform. For example, there can be a water filter that needs to be replaced and/or cleaned, or batteries for smoke/fire/carbon monoxide detection, or the cleaning of the coils on the back of a refrigerator, among other periodic tasks, all of which are encompassed with the aspects of the embodiments.

Method step 308 has several components to it: first, the tenant opens AC Filter App 210 and takes a photo of the old air filter 120, preferably with universal product code (UPC) 214 showing, in the HVAC system of the tenant's residence. Then, the tenant takes a photo of new air filter 212, with UPC 214 showing, to illustrate that the proper air filter is being inserted into the HVAC system, and finally, the tenant takes a photo of the installed new air filter 214, again preferably with UPC 214 showing. The term “a photo” is not to be taken in a limiting sense; it may be necessary to take several photos for each of these steps; AC Filter App 210 provides for such scenarios, and queries the tenant as to whether additional photos are needed for each sub-step, and when the tenant is satisfied, the tenant can click or press a button on the GUI (discussed below in regard to FIGS. 4A-4H) that indicates that particular sub-step has been accomplished.

In method step 310, method 300 recognizes that all three sets of photos have been taken, and requests the user to authorize determining the location of the tenant through use of a GPS App, a location determining App provided through the cellular network, or some combination thereof. In order to successfully complete the terms of the lease contract, and proper use of AC Filter App 210, AC Filter Main App 222, and AC Filter Report App 230, the tenant must allow determination of the tenant's current location, prior to the tenant sending the photos to server 216. According to further aspects of the embodiments, UPC 214 can be verified through AC Filter App 210 or at server 216 and with AC Filter Main App 222. If the incorrect filter 212 was installed, or attempted to be installed, an alert can be sent to the tenant notifying the tenant of the discrepancy and providing a time period to obtain the proper new filter 214 and install the same.

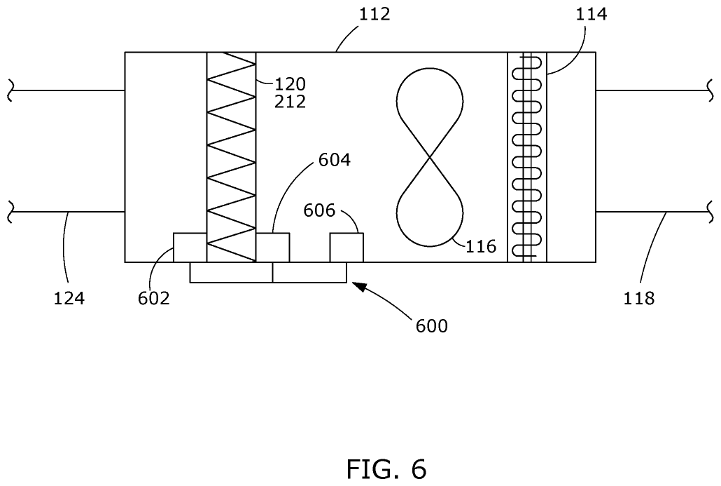

Optional method step 311 follows method step 310. In method step 311, according to aspects of the embodiments, the tenant requests verification of installation of new air filter 212 from filter installation sensor system (sensor system) 600 located in air handler 112, or, optionally, sensor system 600 can automatically communicate with AC Filter App 210 and/or AC Filter Main App 222 via a wireless/wired communications capability (direct internet protocol communication, or WiFi, Bluetooth, or some other wired/wireless means). Further still, sensor system 600 can communicate directly to AC Filter Main App 222 through AC Filter App 210 without alerting the tenant to the communication. Referring to FIG. 6, sensor system 600, according to non-limiting embodiments, comprises an optical transmitter or air pump 602, and optical detector or pressure transducer 604, respectively, and processor/communications circuitry 606. As those of skill in the art can appreciate, over time, air filter becomes filled with dust and other airborne particulates, which results in the necessity to replace the old air filter 120. Such items on air filter 120 impedes the flow of air. Such particulates will also impede the transmission of light through filter 120. As such, an optical transmitter-detector pair can sense over time the degradation of air flow through filter 120, and can, as in this case, confirm that a new filter 212 has been installed as the light transmitted from transmitter 602 will be impeded less in new filter 212.

According to aspects of the embodiments, the optical transmitter 602 can transmit a first optical signal at a known frequency and amplitude. Because of the buildup of dust and particles, optical transmissivity through the old air filter 120 will degrade over time. As such, a detected optical signal will include optical characteristics that include at least a magnitude that show that the transmitted light has been attenuated; conversely, new air filter 212 will allow more light to pass through, and a detected optical signal will include optical characteristics that include a magnitude that show that the light has not been attenuated significantly. Such optical characteristics/magnitudes can be stored in a table on server 216, according to air filter type (e.g., stored by UPC and/or size), and accessible by HVAC Filter Main App 222.

In a substantially similar manner, installation of new air filter 212 can be confirmed by testing the flow of air through the filter using a small air pump 602 and pressure transducer that can measure the flow of air through new filter 212.

According to further aspects of the embodiments, air pump 602 can pump a first flow of air at a known amplitude (pressure). Because of the buildup of dust and particles, air transmissivity through the old air filter 120 will degrade over time. As such, a detected air signal will include characteristics that include at least a magnitude that show that the pumped air has been attenuated; conversely, new air filter 212 will allow more air to pass through, and a detected air signal will include characteristics that include a magnitude that show that the pumped air has not been attenuated significantly. Such transmitted or pumped air pressure characteristics/magnitudes can be stored in a table on server 216, according to air filter type (e.g., stored by UPC and/or size), and accessible by HVAC Filter Main App 222.

The operation of such optical transmitters, air pumps, optical detectors, and pressure transducers are known to those of skill in the art, as is the operation of processor/communications circuitry 606, and as such, a more detailed discussion of the same is neither needed to understand operation of the aspects of the embodiments, and beyond the scope of this discussion, and thus in fulfillment of the dual purposes of clarity and brevity has been omitted from herein.

According to further aspects of the embodiments, another means for verifying installation of the correct new air filter 212 is when a photo has been taken, as described above in regard to method step 308, the size of new air filter 212 can be ascertained and matched to the known requirements of the HVAC system that is installed in the residence of that the Tenant leases.

In method step 312, the tenant clicks send, and the sets of photos (and optionally a verification of installation of new filter message as discussed in regard to method step 311) are uploaded to server 216. In method step 314, server 216 and AC Filter Main App 222 receives the photos (and verification of installation of new filter message, if sent), determines from which tenant and address they have been sent from, verifies the information, and if all is in accordance with the data previously stored in memory 220 of server 216 and AC Filter Main App 222, sends a confirmation of installation of new air filter 212 report to both the tenant via text and/or email, and to the landlord, also via text and/or email. Or, if there has been some sort of discrepancy, the same is noted and both the tenant and landlord can be notified in a substantially similar manner, or other variations of notifications are possible. As described above, UPC 214 can be used by either AC Filter App 210 and/or AC Filter Main App 222 to verify the correct new filter 212 has been installed.

Each transmission to server 216 by the tenant and by server 216 and AC Filter Main App 222 to the tenant and landlord is stored, and retrievable by at least the landlord, and in some aspects of the embodiments the tenant, and according to further aspects of the embodiments, there can be different classifications of data accessible by the tenant and landlord differently, set up according to pre-defined rules.

FIGS. 4A-4G illustrate a plurality of graphical user interface (GUI) diagrams/screenshots displayed on PED/MD 202 of a tenant—user upon which AC-Filter App 210 has been installed according to aspects of the embodiments. FIGS. 4A-4E illustrate the now-familiar process through which a user (in this case a tenant) finds and downloads an application for use on a “smartphone” or MD 202 as known to those of skill in the arts. In fulfillment of the dual purposes of clarity and brevity, a detailed discussion of FIGS. 4A-4H is not necessary as those of skill in the art can appreciate the process; however, a brief review of the same is provided. In FIGS. 4A-4E, a tenant whose name and personal information has been entered by a landlord using AC Filter Report App 230 into AC Filter Main App 222, and stored on server 216, can search for and find AC-Filter App 210 (FIGS. 4A-4C; GUIs 402-406), download the same (FIG. 4D; GUI 408), and have it installed and saved on their MD 202 (FIG. 4E; GUI 410).

In FIG. 4F there is shown GUI 412, which is discussed and used in regard to Method 300, method step 304 according to aspects of the embodiments. In GUI 412, the tenant enters his/her personal information, including email address(es) and phone number(s) at which emails/texts can be received. Such interactive GUIs and collection of personal and contact information are known to those of skill in the art, and therefore, in fulfillment of the dual purposes of clarity and brevity, need not be discussed in greater detail.

In FIG. 4G, there is shown GUI 414, which is discussed and used in regard to Method 300, method step 308 according to aspects of the embodiments. In GUI 414, the tenant is interacting with AC-Filter App 210 and taking photos to verify replaced of old filter 120 with new filter 212. GUI 414 shows three interactive buttons 416, 418, 420, which prompt the tenant to take the required photo or photos. By way of non-limiting example, one manner of use of buttons 416, 418 and 420 can be that the tenant, upon receiving the reminder text in method step 306 opens AC-Filter App 210 (and after obtaining a new air filter 212), finds GUI 414 open, and clicks button 416; the tenant then takes several photos which are stored in AC-Filter App 210; AC-Filter App 210 then asks if the tenant wants to send all the photos taken (in a non-limiting example, limited to between 1 and 10 photos), and if the tenant responds yes, the photos are stored for later transmission. AC-Filter App 210 then returns the tenant to GUI 414, and button 418 can be selected, and the process repeated for the photos of new air filter 212; likewise for button 420, and the photos of the newly installed new air filter 212 in the HVAC system. Upon return to GUI 414, the tenant then authorizes transmission of position information using GPS and/or cellular position determination services, using button 422. Once such authorization is granted, the user can then click “send” using button 424 and the photos are uploaded to server 216 and AC Filter Main App 222. A confirmation of receipt of the transmission of the photos of the new and old air filters 212, 120, can be indicated by indicator button 426, and pre-defined texts/emails can be sent by AC Filter Main App 222 to both the landlord via AC Filter Report App 230 (and/or the landlord's email address/phone number for emails and texts, respectively), and the tenant via AC-Filter App 210 and/or the tenant's email address/phone number for emails and texts, respectively). Such emails and/or texts can include smaller versions of the sent photos, and other pertinent information, as defined by the administrator of network 200 and method 300, and/or landlord according to aspects of the embodiments.

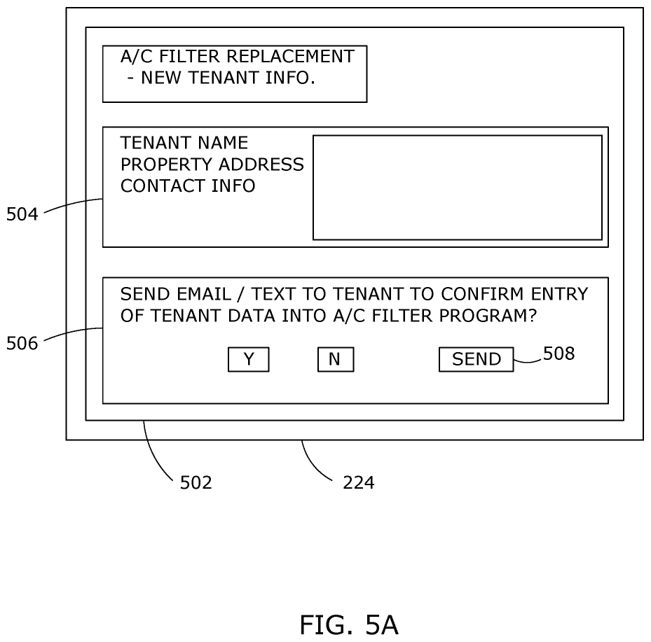

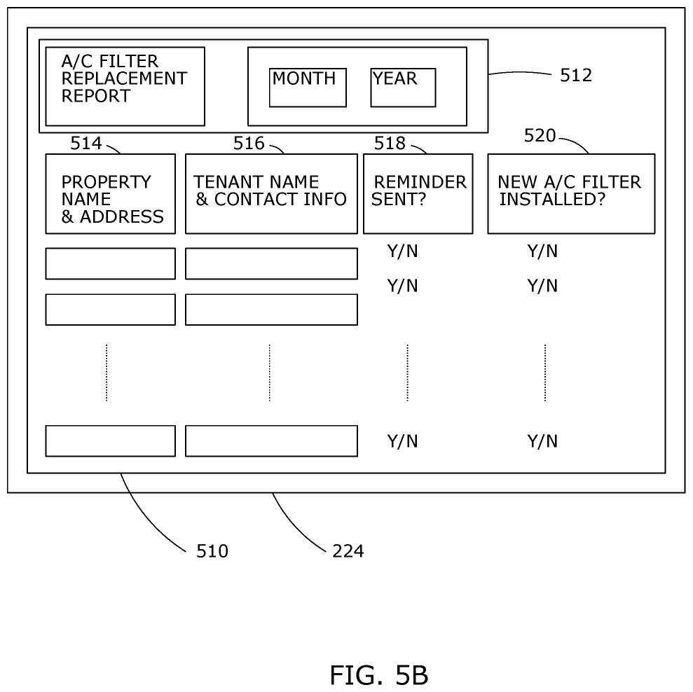

FIGS. 5A and 5B illustrate first and second GUIs 502, 504 displayed on a PED, PC, and/or MD of a property owner/property manager—user upon which AC Filter Report App 230 has been installed according to aspects of the embodiments. Although any one of the aforementioned devices (PC, PED, MD) can be used by the landlord/property owner, reference will only be made to use of PC 224, and a landlord, but the discussion thereof is not to be taken in a limiting manner. In GUI 502, the landlord enters tenant information into AC Filter Report App 230. Typically, the landlord will purchase or lease use of AC Filter Report App 230 for a certain number of tenants and property addresses from the administrator of network 200 and method 300. Upon completion of the lease/purchase, or when subsequent tenants rent properties owned or managed by the landlord, the landlord needs to enter some basic information to register the tenant and give the tenant access to AC Filter App 230, and this is done through AC Filter Report App 230. The form of GUI 502 is substantially similar to many existing name and contact information data entry forms as can be appreciated by those of skill in the art. In data entry field 504 the new tenant's contact and rental property information is entered, and in field 506, the landlord can request a text/email from AC Filter Main App 222 when the tenant enters their information into AC Filter App 210 by clicking the desired “Yes/No” button. Once all the information has been entered, the landlord can click “send” button 508, and the data is sent to AC Filter Main App 222.

GUI 510, shown in FIG. 5B, is a non-limiting example of a type of report that can be generated by AC Filter Main App 222, typically on a monthly basis. Banner portion 512 shows the title of the report and for the respective month; typically, such reports can be generated monthly, although other periods of reports can be used. Data field 514 contains the property name and property address of the tenant, data field 516 contains the name and contact information for the tenant, data field 518 shows that one or more reminder alerts for the month of the report were sent, and data field 520 shows confirmation of installation of new air filter 212. Those of skill in the art can appreciate that this is but a very simplified version of what such an electronic report can include, and many other data fields are possible, with differing formats, and the like, and as such is not meant to be limiting, and should not be taken as such.

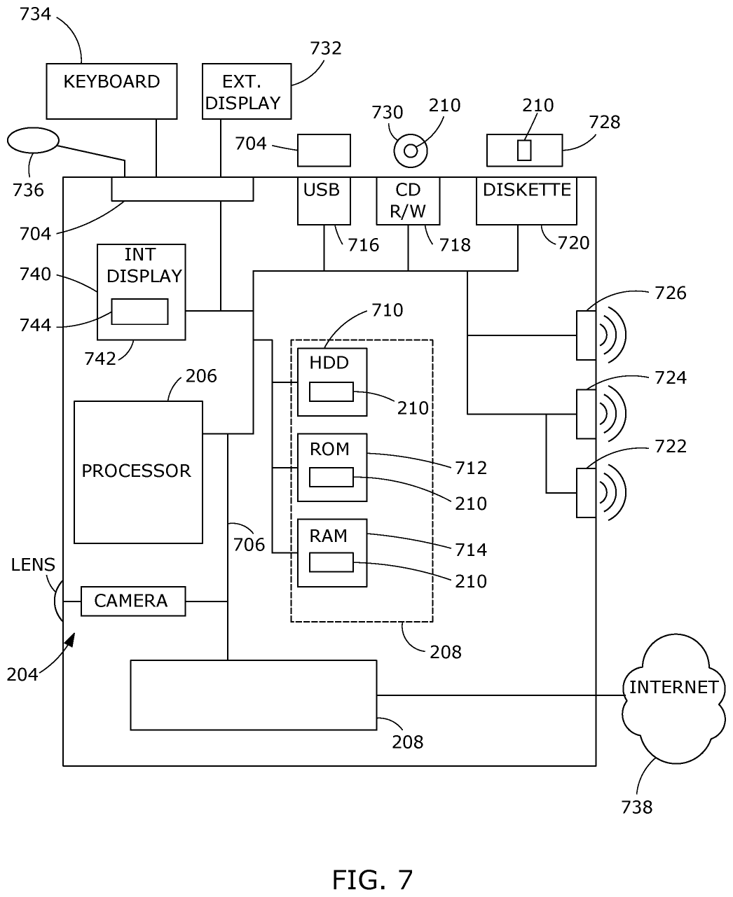

FIG. 7 illustrates a functional block diagram of mobile device (MD) 202 that can be used with AC Filter App 210, AC Filter Main App 222, and AC Filter Report App 230 according to aspects of the embodiments. As those of skill in the art can appreciate, many, if not most of the components shown and described in regard to FIG. 7 are equally applicable to PC 223, and server 216, although each will have different, substantially non-germane capabilities. For the purposes of this discussion, the description and illustration in regard to FIG. 7 applies substantially equally to the aforementioned devices PC 224 and server 216, and therefore, in fulfillment of the dual purposes of clarity and brevity, a detailed discussion thereof has been omitted from herein.

FIG. 7 illustrates a function block diagram of MD 202 as shown in FIG. 2. According to aspects of the embodiments, implementation of method 300 can occur in one or more of MD 202, PC 224, and server 216, through use of one or more of AC Filter App 210, AC Filter Main App 222, and AC Filter Report App 230 according to aspects of the embodiments. Each of said devices comprises one or more processors 206, 226, and 218, respectively, and memory 208, 228, and 220, respectively.

Those of ordinary skill in the art in the field of the embodiments can appreciate that the functionality of the processor(s) can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices. Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures.

MD 202 includes, among other items, internal data/communications bus (bus) 706, processor(s) 206 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 716, compact disk (CD)/digital video disk (DVD) read/write (R/W) drive 718, floppy diskette drive 720 (though less used currently, there are still many PCs that include this device), and memory 208.

Memory 208 (which can also be referred to as a data storage unit) itself can comprise hard disk drive (HDD) 710 (these can include conventional magnetic storage media, but, as is becoming increasingly more prevalent, can include flash drive-type mass storage devices, among other types), ROM device(s) 712 (these can include electrically erasable (EE) programmable ROM (EEPROM) devices, ultra-violet erasable PROM devices (UVPROMs), among other types), and random access memory (RAM) devices 714. Usable with USB port 716 is USB/FD/BT device 704, and usable with CD/DVD R/W drive 718 are CD/DVD disks 730 (which can be both read and write-able). Usable with diskette drive 720 are floppy diskettes 728. Each of the memory storage devices, or the memory storage media (710, 712, 714, 704, 730, and 728, among other types), can contain parts or components of, or in its entirety, executable software programming code (software; AC Filter App 210, AC Filter Main App 222, and AC Filter Report App 230 according to aspects of the embodiments that can implement part or all of the portions of the method described herein). Further, processor 206 itself can contain one or different types of memory storage devices (most probably, but not in a limiting manner, RAM memory storage media 714) that can store all or some of the components of AC Filter App 210, AC Filter Main App 222, and AC Filter Report App 230 according to aspects of the embodiments.

In addition to the above described components, MD 202 can also include external keyboard 734, external display 732 (while typically MD 202 can be a smart phone, or tablet, which would not typically have external devices connected to it, MD 202 can be a more conventional personal computer, laptop, or even tablet, all of which can or do have external components connected to them), and mouse 736 (which can also be wireless, as can also external keyboard 734, and external display 732). All of these components are known to those of ordinary skill in the art, and this description includes all known and future variants of these types of devices. Internal display 742 can be any type of known display or presentation screen, such as liquid crystal displays (LCDs), light emitting diode displays (LEDs), plasma displays, cathode ray tubes (CRTs), among others. One or more user interface mechanisms can also be present such as a microphone, touch pad, touch screen, voice-recognition system, among other interactive inter-communicative devices. Internal display 742 can also be a touch screen interface and thus can incorporate a touch-screen keyboard 744.

MD 202 can access internet 738, either through a hard wired connection, via Ethernet interface 706 directly, or wirelessly via one or more of BT transceiver 722, near-field communication (NFC) antenna 724, and Wi-Fi/wireless antenna 726. MD 202 can be coupled to other computing devices, via one or more networks. MD 202 can be part of a larger network configuration as in a global area network (GAN) (e.g., internet 738), which ultimately allows connection to various landlines.

MD 202 can be used to implement method 300 for verifying installation of new air filter 212 according to aspects of the embodiments. Hardware, firmware, software or a combination thereof may be used to perform the various steps and operations described herein. According to aspects of the embodiments, AC Filter App 210, AC Filter Main App 222, and AC Filter Report App 230 according to aspects of the embodiments for carrying out the above discussed steps can be stored and distributed on multi-media storage devices such as devices 710, 712, 714, 704, 730, and/or 728 (described above) or other form of media capable of portably storing information. These storage media may be inserted into, and read by, devices such as the CD-ROM drive 718, disk drives 718, 720, among other types of software storage devices.

As also will be appreciated by one skilled in the art, the various functional aspects of the embodiments may be embodied in a wireless communication device, a telecommunication network, as a method, or in a computer program product. Accordingly, the embodiments may take the form of an entirely hardware embodiment or an embodiment combining hardware and software aspects. Further, the embodiments may take the form of a computer program product stored on a computer-readable storage medium having computer-readable instructions embodied in the medium. Any suitable computer-readable medium may be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and non-volatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or non-volatile memory such as read only memory (ROM) and/or random-access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/non-volatile computer storage media. For example, the processor can access a hard disk drive that reads from or writes to non-removable, non-volatile magnetic media, a magnetic disk drive that reads from or writes to a removable, non-volatile magnetic disk, and/or an optical disk drive that reads from or writes to a removable, non-volatile optical disk, such as a CD-ROM or other optical media. Other removable/non-removable, volatile/non-volatile computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

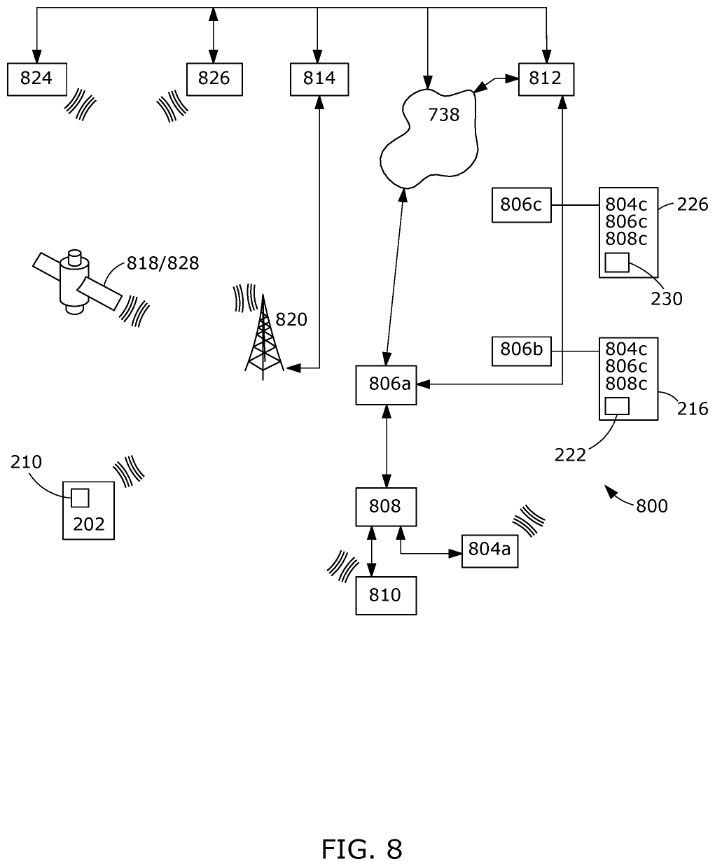

FIG. 8 illustrates a block diagram of network system (network) 800 within which the system and method for verifying installation of a new HVAC air filter can be implemented according to aspects of the embodiments. Much of the network system infrastructure shown in FIG. 8 is or should be known to those of skill in the art, so, in fulfillment of the dual purposes of clarity and brevity, a detailed discussion thereof shall be omitted. According to further aspects of the embodiments, network 200, described above in regard to FIG. 2, can be considered to be part of network 800; thus, several of the components of network 200 are shown in network 800.

According to aspects of the embodiments, the tenant user of the above described system and method can have AC Filter App 210 stored on their MD 202; MDs 202 can include, but are not limited to, so-called smart phones, tablets, personal digital assistants, notebook and laptop computers, and essentially any device that can access the internet and/or cellular phone service or can facilitate transfer of the same type of data in either a wired or wireless manner. For purposes of this discussion, the tenant has been discussed as using only MD 202, i.e., a smartphone, though such discussion should be understood to be in a non-limiting manner in view of the discussion above about the other types of devices that can access, use, and provide such information.

In FIG. 8, the tenant has MD 202, which can access cellular service provider 814, either through a wireless connection (cellular tower 820) or via the tenant's home communications system that includes a wireless/wired interconnection (a “Wi-Fi” system that comprises, e.g., modulator/demodulator (modem) 808a, wireless router 810a, and personal computer (PC)/server 804a. Internet service provider (ISP) 806a is the tenant's ISP (which can be the same or different from that of the landlord's and administrator's) that accesses internet 738. Further, MD 202 can include near field communication (NFC), “Wi-Fi,” and Bluetooth (BT) communications capabilities as well, all of which are known to those of skill in the art and were described above in regard to FIG. 7.

According to further aspects of the embodiments, network 800 further includes landlord PC 216 that can include wireless router 810b, and modem 808b. Thus, PC 216 can connect to ISP 806b and internet 738 via internal modem 808b to provide internet-based communications in the appropriate format to end users. Such communication pathways are well known and understand by those of skill in the art, and a further detailed discussion thereof is therefore unnecessary.

According to further aspects of the embodiments, network 800 further includes administrator server 226 that can include wireless router 810c, and modem 808c. Thus, Server 226 can connect to ISP 806c and internet 738 via internal modem 808c to provide internet-based communications in the appropriate format to end users. Such communication pathways are well known and understand by those of skill in the art, and a further detailed discussion thereof is therefore unnecessary.

MD 202, as well as PC 216 and server 226, can also access global positioning system (GPS) satellite 828, which is controlled by GPS station 824, to obtain positioning information (which can be useful for different aspects of the embodiments), or MD 202 can obtain positioning information via cellular service provider 814 using one or more cell tower(s) 820 according to one or more well-known methods of position determination. Some MDs 202 can also access communication satellites 818 and their respective satellite communication systems control stations 826 (the satellite in FIG. 8 is shown common to both communications and GPS functions) for near-universal communications capabilities, albeit at a much higher cost than convention “terrestrial” cellular services. MD 202 can also obtain positioning information when near or internal to a building (or arena/stadium) through the use of one or more of NFC/BT devices, the details of which are known to those of skill in the art. FIG. 8 also illustrates other components of network 800 such as plain old telephone service (POTS) provider 812.

According to further aspects of the embodiments, and as described above, network 800 further comprises server 216 that includes AC Filter Main App 222, wherein one or more processors, using known and understood technology, such as memory, data and instruction buses, and other electronic devices, can store and implement code that can implement the system, methods, and modes for verifying installation of a new HVAC air filter according to aspects of the embodiments.

According to further aspects of the embodiments, and as described above, network 800 further comprises PC 216 that includes AC Filter Report App 230, wherein one or more processors, using known and understood technology, such as memory, data and instruction buses, and other electronic devices, can store and implement code that can implement the system, methods, and modes for verifying installation of a new HVAC air filter according to aspects of the embodiments.

The disclosed embodiments provide hardware, firmware, computer software, and a method for reminding and verifying that an HVAC air filter has been replaced. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

Although the features and elements of the embodiments are described in the embodiments in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

I claim:

1. A method for verifying replacement of an air filter in a heating ventilation and air conditioning (HVAC) system in a building, the method comprising:
accessing an HVAC system air filter replacement verification software application (HVAC Filter App) on a mobile device (MD);
using a camera on the mobile device as prompted by the HVAC Filter App to take one or more photos of an old air filter as installed in the HVAC system (first set of photos);
saving the first set of photos on the MD;
using a camera on the mobile device as prompted by the HVAC Filter App to take one or more photos of a new air filter prior to being installed in the HVAC system (second set of photos);
saving the second set of photos on the MD;
using a camera on the mobile device as prompted by the HVAC Filter App to take one or more photos of the new air filter as installed in the HVAC system (third set of photos);
saving the third set of photos on the MD;
forwarding the first, second, and third set of photos using the HVAC Filter App; and
performing a comparison of the first, second, and third set of photos to verify the new air filter has been installed in the HVAC system.

2. The method according to claim 1, further comprising:
verifying a location of the installation of the new air filter and the MD using a global positioning system (GPS) application accessible by the mobile device.

3. The method according to claim 2, wherein the step of verifying a location further comprises:
using a cellular telephone system location determining application (locating determining App) accessible by the MD to determine a location of the MD.

4. The method according to claim 1, wherein the step of performing a comparison comprises:
comparing the old air filter to the new air filter to verify they match;
verifying that the new air filter has been installed in the HVAC system, and that the address of both the HVAC system and MD match, and that the address of the MD match previously stored records of the HVAC system.

5. The method according to claim 1, further comprising:
verifying that the new air filter is a correct replacement air filter for the HVAC system by analyzing a universal product code (UPC) of the new air filter.

6. The method according to claim 1, further comprising;
verifying that the new air filter is a correct replacement air filter for the HVAC system by determining a size of the new air filter and verifying it matches a size requirement of an air filter for the HVAC system at the address of the building.

7. The method according to claim 1, further comprising;
verifying that the new air filter is a correct replacement air filter for the HVAC system by analyzing a universal product code (UPC) and verifying that the new air filter is correct for the HVAC based on records linking the location of the MD, the address of building, and the HVAC recorded as installed at the address of the building.

8. The method according to claim 7, further comprising:
verifying that the new air filter has been installed properly within the HVAC system by testing the new air filter using an optical transmission characteristic of the new air filter.

9. The method according to claim 7, further comprising:
verifying that the new air filter has been installed properly within the HVAC system by measuring airflow through the new filter using an air pump adapted to pump a flow of air through the new air filter, and a pressure measurement transducer adapted to measure the pumped air flow through the new air filter.

10. The method according to claim 9, wherein
the correct air flow orientation of the new air filter can be determined by measuring an air flow through the new filter using an air pump adapted to pump a flow of air through the new air filter, and a pressure measurement transducer adapted to measure the pumped air flow through the new air filter.

11. The method according to claim 1, wherein
the steps of taking the first, second, and third set of photos, and forwarding the same are prompted by the HVAC Filter App stored on the MD.

12. The method according to claim 1, further comprising:
receiving the first, second, and third sets of photos at a server, wherein the server is adapted to store an HVAC Filter Main App that is adapted to receive the three sets of photos, and perform the steps of:
matching a location of the MD forwarding the photos to an address stored in memory for the building;
verifying that the new air filter is a correct replacement for the HVAC system associated with the building;
verifying that the new air filter has been correctly installed into the HVAC system; and
forwarding a first electronic correspondence to a resident of the building confirming the installation of the new air filter, and forwarding a second electronic correspondence to one or more of a landlord, property manager, and owner of the building confirming installation of the new air filter.

13. A system for verifying replacement of a new air filter for an old air filter in a heating venting and air conditioning (HVAC) system in a building, comprising:
a mobile device (MD) belonging to and operated by a resident of the building and adapted to communicate electronically through an electronic communications network (network) and further adapted to take photos with a camera, and which is further adapted to store and execute a set of programming instructions entitled HVAC Filter App, wherein
the HVAC App is adapted to periodically prompt the resident to use the camera to take three sets of photos, wherein
the first set of photos comprise one or more photos of an old air filter as installed in the HVAC system (first set of photos),
the second set of photos comprise one or more photos of a new air filter prior to being installed in the HVAC system (second set of photos),
the third set of photos comprise one or more photos of the new air filter installed into the HVAC system (third set of photos), and wherein
the HVAC App is further adapted to store the three sets of photos, forward the three sets of photos through the network in a first HVAC installation report, and receive electronic correspondence verifying installation of the new air filter into the HVAC system.

14. The system according to claim 13, wherein
the MD is adapted to use one or more of a global positioning system (GPS) application (App) accessible by the MD and cellular telephone network location determining application (location determining App) accessible by the MD to determine a present location of the MD, and
the HVAC Filter App is adapted to retrieve the present location of the MD, and include the present location of the MD in the first HVAC installation report.

15. The system according to claim 13, further comprising:
a first computing device (first computer) belonging to and operated by an administrator, the first computer adapted to communicate electronically through the network and is further adapted to store and execute a set of programming instructions entitled HVAC Filter Main App; and wherein
the HVAC Filter Main App is adapted to:
receive the three sets of photos in the first HVAC installation report,
compare the old air filter to the new air filter to verify they match,
verify that the new air filter has been installed in the HVAC system,
verify that the address of both the HVAC system and MD match,
verify that the address of the MD match previously stored records of the HVAC system, and
send the electronic correspondence verifying installation of the new air filter into the HVAC system.

16. The system according to claim 15, wherein
the second set of photos includes an image of a universal product code (UPC) of the new air filter, and
the HVAC Filter Main App is further adapted to verify that the new air filter is a correct replacement air filter for the HVAC system installed at the building by analyzing the UPC of the new air filter, and by reviewing records linking the location of the MD, the address of building, and the HVAC recorded as installed at the address of the building.

17. The system according to claim 16, wherein
the second set of photos further includes at least one image of the new air filter from which a size of the new air filter can be determined, and wherein
the HVAC Filter Main App is further adapted to verify the new air filter is a correct replacement air filter for the HVAC installed at the building by checking that the size of the new air filter matches a specified size for the replacement air filter for the HVAC system installed at the building.

18. The system according to claim 13, further comprising:
a sensor system adapted to verify that the new air filter has been installed, the sensor system comprising
an optical transmitter adapted to transmit a first optical signal through the new air filter,
an optical detector adapted to receive the transmitted optical signal and output a detection signal, the detection signal including optical characteristics of the receiving optical signal including at least a magnitude of the detected signal, and
a processor adapted to receive the detection signal and evaluate the magnitude of the received optical signal to determine whether a new air filter has been installed in the HVAC system.

19. The system according to claim 13, further comprising:
a sensor system adapted to verify that the new air filter has been properly installed, the sensor system comprising
an air pump adapted to pump a first flow of air through the new air filter,
a pressure transducer adapted to receive the pumped first flow of air and output a detection signal, the detection signal including pumped air characteristics of the received pumped flow of air including at least a magnitude of the detected signal, and
a processor adapted to receive the detection signal and evaluate the magnitude of the received pumped flow of air to determine whether a new air filter has been installed in the HVAC system.

20. The system according to claim 19, further comprising:
a second computing device (second computer) belonging to and operated by one or more of an owner, property manager, and landlord of the building (owner), the second computer adapted to communicate electronically through the network and is further adapted to store and execute a set of programming instructions entitled HVAC Filter Report App, and wherein
the HVAC Filter Report App is adapted to accept information pertaining to a new user of the system input by the owner, and add the new use to the system by preparing and transmitting first new user correspondence to the user, and by preparing and transmitting second new user correspondence to the first computer and the HVAC Filter Main App, and further wherein
the HVAC Filter Main App is further adapted to prepare periodic reports on one or more users of the system and send the same to the owner periodically.
